(19) United States
(12) Patent Application Publication
(10) Pub. No.: US 2008/0018663 A1
(43) Pub. Date: Jan. 24, 2008

(54) Access structure for internal memory of driving control elements

(75) Inventor: Wei-Yeh Sun, Taipei City (TW)

Correspondence Address: BIRCH STEWART KOLASCH & BIRCH, PO BOX 747, FALLS CHURCH, VA, 22040-0747, US

(73) Assignee: Sitronix Technology Corp.

(21) Appl. No.: 11/488,015

(22) Filed: Jul. 18, 2006

(51) Int. Cl. G09G 5/02

(52) U.S. Cl. 345/603

(57) ABSTRACT

An access structure for an internal memory of driving control elements includes a transformation and compression module to transform three primary color signals of graphic data to YCbCr signals and compress the YCbCr signals, thereby to reduce storage requirement so that a given internal memory in a driving control element can store bigger or more image and graphic data, a memory module to store the compressed YCbCr signals and a decompression transformation module to read and decompress the compressed YCbCr signals, and transform the YCbCr signals to three primary color signals to output image data.

### FIELD OF THE INVENTION

The present invention relates to a signal process technique for driving control elements of display devices and particularly to an access structure for lowering the usage of internal memory of driving control elements.

### BACKGROUND OF THE INVENTION

The present technique for display devices to display image data generally has to store the image and graphic data first in a RAM (random access memory) inside a driving control element of the display devices then drive the display screen of the display devices in an image displaying mode.

However when the image and graphic data is huge, it occupies a lot of memory space in the driving IC. Refer to FIG. 1 for a schematic view of accessing an internal memory 11 of a conventional driving control element 10. Assumed that each pixel of an image data is composed of three primary colors (RGB) consisting of 8 bits R (red), 8 bits G (green) and 8 bits B (blue), during accessing the memory 11, each pixel occupies 24 bits of memory space. To perform output, 24 bits of data are retrieved from the memory 11 and sent to the circuit of the display screen.

Such a memory access structure of direct storing and retrieval is widely demanded in the present displaying technique. With the image and graphic data become increasingly huge, the memory in the driving control element 10 has to allocate a greater amount of space to store the image and graphic data. In serious cases, displaying the image and graphics could be difficult or impossible because the image and graphics have occupied too much memory space. The commonly adopted remedy at present is to increase the capacity of the memory 11 of the driving control element 10. This results in increasing of the size of the chip set and the production cost of the driving control element 10.

### SUMMARY OF THE INVENTION

Therefore the object of the present invention is to solve the aforesaid disadvantages. The invention aims to transform and compress the data of three primary colors of each pixel of image and graphics, then store the transformed and compressed data in the internal memory of a driving control element to reduce the storage requirement. Thereby a given memory space in the driving control element can store larger or more image and graphic data.

To achieve the foregoing object, the access structure of the invention includes a transformation compression module to transform the three primary color signals of graphic data to YCbCr signals and compress the YCbCr signals, a memory module to store the compressed YCbCr signals and a decompression transformation module to read the compressed YCbCr signals and decompress and transform the YCbCr signals to three primary color signals to output the image data.

The transformation compression module includes a first transformation circuit to transform the three primary color signals of each pixel to the YCbCr signals and a compression circuit to compress and sample the YCbCr signals according to MPEG (Motion Pictures Expert Group) standards.

The decompression transformation module includes a decompression circuit to decompress the YCbCr signals according to a sampling ratio to become YCbCr signals of each pixel, and a second transformation circuit to transform the YCbCr signals of each pixel to three primary color signals to output the image data.

The compression and sample process is accomplished by selecting one of the following rules: Y:Cb:Cr=4:2:2, Y:Cb:Cr=4:1:1 (or 4:2:0) and Y:Cb:Cr=2:1:1.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional access structure for internal memory of a driving control element.

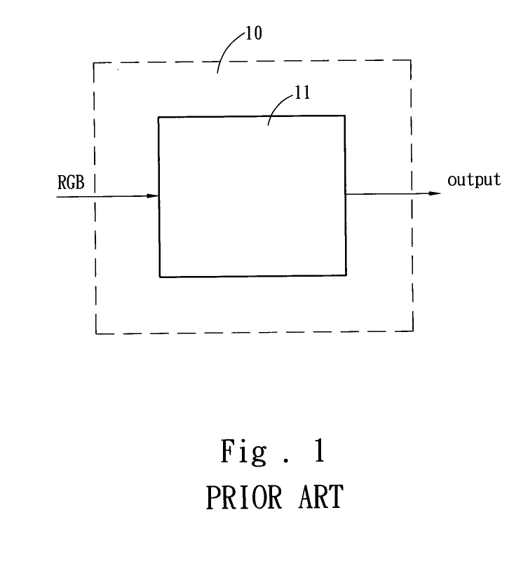

FIG. 2 is a schematic view of the access structure for internal memory of driving control elements of the invention.

### DETAILED DESCRIPTION OF THE PREFERRED EMBODIMENTS

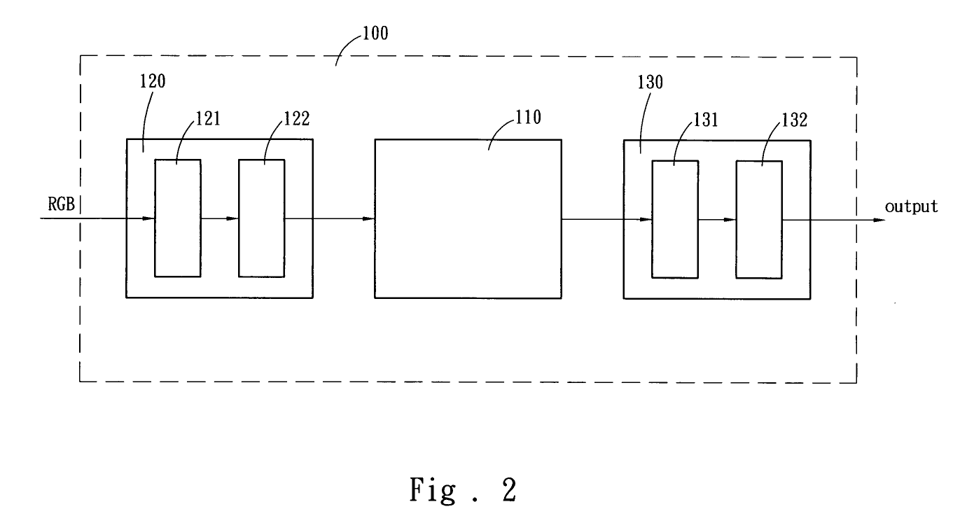

Please refer to FIG. 2, the access structure according to the invention is located in a driving control element 100 of a display and includes a transformation compression module 120 to transform three primary colors (RGB) signals of graphic data to YCbCr signals and compress the YCbCr signals. The transformation compression module 120 has a first transformation circuit 121 to transform the three primary colors (RGB) signals of every pixel to the YCbCr signals, and a compression circuit 122 to compress and sample the YCbCr signals according to MPEG (Motion Pictures Expert Group) standards. The compression and sampling process is accomplished by selecting one of the following rules: Y:Cb:Cr=4:2:2, Y:Cb:Cr=4:1:1 (or 4:2:0) and Y:Cb:Cr=2:1:1.

The access structure also includes a memory module 110 to store the YCbCr signals, and a decompression transformation module 130 to read the compressed YCbCr signals, then decompress and transform the YCbCr signals to the three primary color signals to be output. The decompression transformation module 130 includes a decompression circuit 131 to decompress the compressed and sampled YCbCr signals to YCbCr signals of each pixel according to the sampling ratio, and a second transformation circuit 132 to transform the YCbCr signals of each pixel to the three primary color signals to be output.

As colors seen by human eyes are caused by different wavelength of light, experiments show that human eyes are especially keen to three wavelengths. By adjusting the intensity of these three types of light, human eyes almost can see all colors.

These three types of light are the primary colors of light RGB, namely Red (R), Green (G) and Blue (B). All TV sets and screens have light generating apparatus to generate these three basic lights. Mixing these three types of lights can present all colors. In computers, color is indicated by the value of digital signals of the three primary colors RGB. Each color is represented by 8 bits, and thus has, 0-255, in total 256 kinds of luminance variations. With three colors, there are total some sixteen million variations. It is commonly called 24 bits full color.

In the YCbCr signals, Y is the grey value or luminance value of transforming color to a grey scale image. The transformation formula mainly is set according to the sensitivity of human eyes to the three primary colors RGB. The greater the value the greater the sensitivity. For instance, with the color sensitivity of G (0.587), R (0.299) and B (0.114), transforming the three primary colors RGB to the YCrCb signals can be done as follows:

Y=0.299R+0.587G+0.114B

Cb=−0.168R−0.331G−0.499B

Cr=0.500R−0.419G−0.081B

while transforming the YCrCb signals to the three primary colors RGB can be done as follows:

R=Y+104020(Cr−128)

G=Y−0.3441(Cb−128)−0.7141(Cr−128)

B=Y+107720(Cb−128)

As human eyes are more sensitivity to the data of low frequency than the high frequency, and also are more sensitivity to alteration of luminance than color, when adopted for display devices, the general approach is to process only grey scale and full color images. The full color images are composed of three color components Y, Cb and Cr. The grey color images have only luminance but no color, thus have only the component Y As Y represents luminance, while Cb and Cr represent chrominance, the component of Y is more important.

Therefore the invention first transforms the graphic data of the three primary colors RGB to YCrCb signals; then samples and compresses the signals according to a sampling ratio selected from Y:Cb:Cr=4:2:2, Y:Cb:Cr=4:1:1 (or 4:2:0) or Y:Cb:Cr=2:1:1; and stores the compressed signals in the memory module 110 of the driving control element 100. Thereby the size of the memory module 110 in the driving control element 100 can be reduced. During output, the compressed YCrCb signals are decompressed according to the sampling ratio to YCrCb signals of each pixel that are transformed to the three primary colors RGB signal format to output image data.

Take one set of three primary color RGB signal that consists of 8 bits R, 8 bits G and 8 bits B as an example. When the graphic data of the three primary color RGB signal is first transformed to the YCrCb signal, the data of the three primary colors RGB and YCrCb signal of each pixel are 24 bits (8+8+8).

After compression and sampling according to Y:Cb:Cr=4:2:2, each pixel has a luminance value Y, and every four pixels have two chrominance values Cb and Cr. Thus for the original pixel that requires 24 bits, after adopting the sampling ratio, each pixel requires only (4×8+2×8+2×8)/4=16 bits. As a result, each pixel occupies only 16 bits of space in the memory module 110. Hence for a given graphic data, one third of storage space can be saved than the original three primary color RGB data. Similarly, after compression and sampling according to Y:Cb:Cr=4:1:1 (or 4:2:0), each pixel has a luminance value Y, and every four pixels have one chrominance value Cb and Cr. Thus for the original pixel that requires 24 bits, after adopting the sampling ratio, each pixel requires only (4×8+2×8)/4=12 bits. As a result, each pixel occupies only 12 bits of space in the memory module 110. Hence for a given graphic data, one half of storage space can be saved than the original three primary color RGB data.

Similarly, after compression and sampling according to Y:Cb:Cr=2:1:1 and MPEG standards, each pixel has a luminance value Y, and every two pixels have one chrominance value Cb and Cr. Thus for the original pixel that requires 24 bits, after adopting the sampling ratio, each pixel requires only (2×8+8+8)/4=16 bits. As a result, each pixel occupies only 16 bits of space in the memory module 110. Hence for a given graphic data, one third of storage space can be saved than the original three primary color RGB data.

By means of the invention, the three primary color data of each pixel of image and graphics are transformed and compressed, then are stored in the memory of the driving control element, thus can reduce storage requirement and storage space of the memory in the driving control element. Therefore a given memory in the driving control element can store bigger or more image and graphic data.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An access structure for an internal memory of driving control elements that is located in a driving control element of a display device, comprising:
a transformation compression module to transform first three primary color signals of graphic data to YCbCr signals and compress the YCbCr signals;
a memory module to store the compressed YCbCr signals; and
a decompression transformation module to read the compressed YCbCr signals and decompress and transform the YCbCr signals to second three primary color signals to be output.

2. The access structure of claim 1, wherein the transformation compression module includes a first transformation circuit to transform the first three primary color signals of each pixel to the YCbCr signals, and a compression circuit to compress and sample the YCbCr signals according to MPEG (Motion Pictures Expert Group) standards.

3. The access structure of claim 2, wherein the compress and sample is performed by selecting one of process rules which include Y:Cb:Cr=4:2:2, Y:Cb:Cr=4:1:1 and Y:Cb:Cr=2:1:1.

4. The access structure of claim 1, wherein the decompression transformation module includes a decompression circuit to decompress the compressed and sampled YCbCr signals according to a sampling ratio of the YCbCr signals to become YCbCr signals of each pixel and a second transformation circuit to transform the YCbCr signals of each pixel to three primary color signals to be output.
